(19) United States
(12) Patent Application Publication
(10) Pub. No.: US 2006/0171705 A1
(43) Pub. Date: Aug. 3, 2006

(54) Automatic tracking system

(76) Inventors: James P. Slupe, Caldwell, ID (US); Fred R. Wiedeback, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,003

(22) Filed: Jan. 31, 2005

(51) Int. Cl. G03B 17/00

(52) U.S. Cl. 396/427

(57) ABSTRACT

An automatic tracking system is built including a base, a rotating element, a pair (or more) of receiving elements, a motor, and a controller electrically coupled to the receiving elements and the motor, configured to operate as a direction finder. The motor rotates the rotating element to keep the receiving elements aligned with the signal from a portable transmitter. When a camera is mechanically coupled with the rotating element, the direction finder will keep the camera aligned to the portable transmitter as it moves with respect to the camera. Subject distance may also be calculated by the controller and sent to an image capture device as the focus distance to be used by the image capture device.

### FIELD OF THE INVENTION

The present invention relates generally to the field of image capture devices, and more particularly to the field of automatic tracking of subjects by image capture devices.

### BACKGROUND OF THE INVENTION

As many parents with still or video cameras are discovering, it is very difficult to track a single subject for long periods of time, such as during a sporting event. Players tend to move very quickly in many sports, requiring the continual tracking of the subject in both the aim of the camera and the focus of the camera. While quality photographs may be taken by pre-aiming and pre-focusing on a region of the playing field and waiting for the subject to enter the region, this technique results in a small quantity of quality images, and is virtually useless in video applications.

Also, during long sporting events, it is very difficult to remain steady and alert with a camera while continually panning and re-focusing on a subject. In some sports, such as golf or baseball, it may be useful for a video camera to accurately track the ball on its trajectory while continuing to keep the ball in focus. Needless to say, this is very difficult to do manually. There are a wide variety of situations where automatic panning and focus of an image capture device would be necessary, including tracking animals or other moving objects.

### SUMMARY OF THE INVENTION

An automatic tracking system is built including a base, a rotating element, a pair (or more) of receiving elements, a motor, and a controller electrically coupled to the receiving elements and the motor, configured to operate as a direction finder. The motor rotates the rotating element to keep the receiving elements aligned with the signal from a portable transmitter. When a camera is mechanically coupled with the rotating element, the direction finder will keep the camera aligned to the portable transmitter as it moves with respect to the camera. Subject distance may also be calculated by the controller and sent to an image capture device as the focus distance to be used by the image capture device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a perspective view of an automatic tracking system according to the present invention.

FIG. 2 is a close-up view of the example embodiment of an automatic tracking system according to the present invention from FIG. 1A.

FIG. 3 is a view of the example embodiment of an automatic tracking system according to the present invention when inverted from the view of FIG. 2.

FIG. 4 is a flow chart of an example embodiment of a method of automatically tracking a transmitter according to the present invention.

### DETAILED DESCRIPTION

This description of the preferred embodiments is intended to be read in connection with the accompanying drawings, which are to be considered part of the entire written description of this invention. In the description, relative terms such as “lower,” “upper,” “horizontal,” “vertical,” “up,” “down,” “top,” “bottom,” “left,” and “right” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

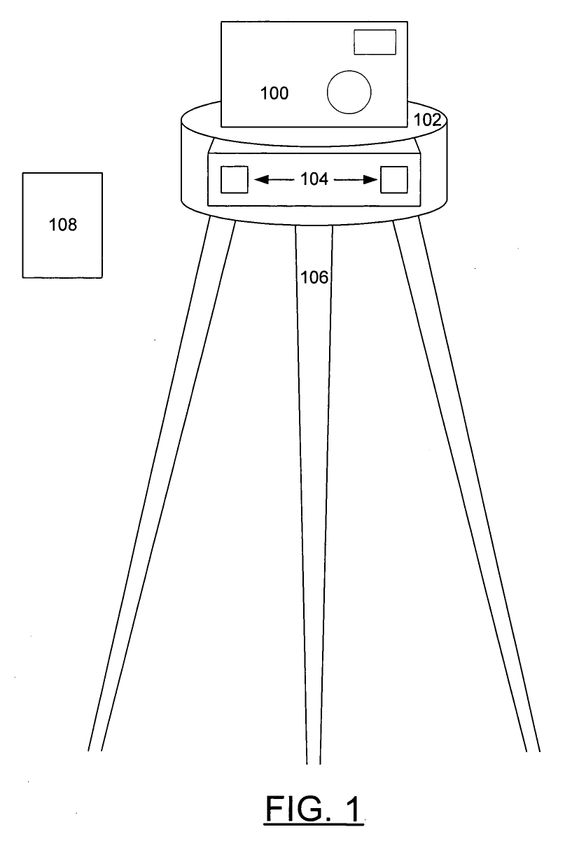

FIG. 1 is a perspective view of an automatic tracking system according to the present invention. In this example embodiment of the present invention, an automatic tracking system 102 is shown including a pair of receiving elements 104, supported by a tripod 106 and supporting a camera 100. In this example embodiment, the pair of receiving elements 104 are used as a direction finding means used to track the location of a transmitter 108. Those of skill in the art will recognize that there are a wide variety of direction finding methods all within the scope of the present invention. For example in a preferred embodiment of the present invention the transmitter may be a 60 GHz transmitter. In this example embodiment, the 60 GHz frequency is used since the Federal Communications Commission (FCC) does not require any licensing for use of the band from about 56 GHz to about 64 GHz. This frequency band is selected since 60 GHz is a resonance frequency of naturally occurring O₂ in the atmosphere. The O₂ absorbs 60 GHz energy, and thus 60 GHz transmissions are only usable for short range communication, which is ideal for this application, since it reduces the likelihood of interference between multiple automatic tracking systems. A further advantage of the 60 GHz frequency band, is that 60 GHz waves have a very short wavelength. Since direction finding error is a function of the separation of the receiving elements and the frequency, accurate direction finding devices may be built which are more compact than what would be required when using longer wavelength bands.

Those of skill in the art will recognize, that while this example embodiment of the present invention uses a pair of receiving elements 104, other embodiments of the present invention may use a greater number of receiving elements 104 within the scope of the present invention. Also, while in this example embodiment of the present invention, the transmitter 108 is a small battery powered 60 GHz transmitter 108, other implementations of the present invention may use other frequency ranges. Also, in some embodiments of the present invention, for use in situations where a plurality of automatic tracking systems are in use in close proximity, it may be desirable to add data to the 60 GHz transmission, such that each transmitter sends different codes (similar to an automatic garage door opener) so that each automatic tracking system may be set to track a single transmitter, and ignore the signals from other transmitters.

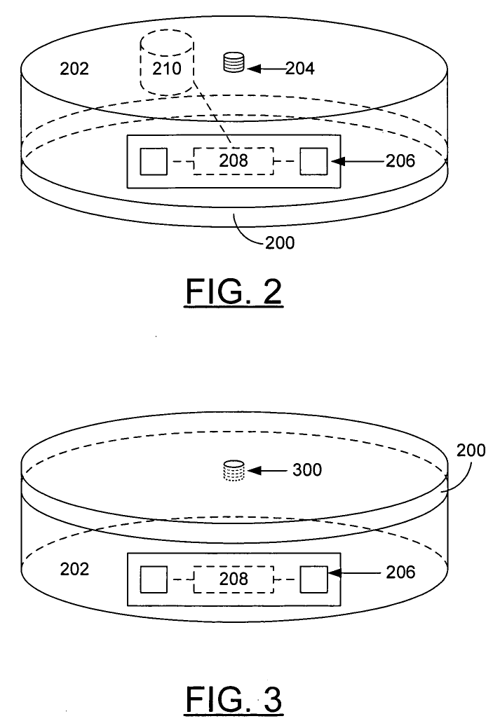

FIG. 2 is a close-up view of the example embodiment of an automatic tracking system according to the present invention from FIG. 1A. In this example embodiment of the present invention an automatic tracking system is built including a base 200, a rotating element 202, a direction finder containing a pair of receiving elements 206, a controller 208, and a motor 210. The rotating element 202 also includes a means for attaching a camera such as a threaded bolt 204 such as those used commonly for attaching cameras to tripods. The controller 208 is electrically coupled to the receiving elements 206, and configured to control the motor 210 which is mechanically coupled with the base 200 and the rotating element 202. The motor 210 is configured to rotate the rotating element 202 with respect to the base 200 when it receives the appropriate signals from the controller 208. Those of skill in the art will recognize that direction finding control methods are well known in the art and any of the possible methods may be incorporated into the controller 208. Also, while not specifically specified in this disclosure, those of skill in the art will recognize that most embodiments of the present invention will include some type of power supply, such as a battery, and a switch to turn off the automatic tracking system when it is not in use. Those of skill in the art will also recognize that there are a wide variety of ways to mechanically couple the motor 210 to the base 200 and the rotating element 202, such as gears, or a belt, all within the scope of the present invention. The controller 208 may also be used in conjunction with the transmitter 108 and receiving elements 206 to calculate the distance from the automatic tracking system to the transmitter 108 and send this information to the image capture device allowing accurate focus on the subject holding the transmitter 108.

FIG. 3 is a view of the example embodiment of an automatic tracking system according to the present invention when inverted from the view of FIG. 2. In this view of the automatic tracking system of FIG. 2, the device has been flipped, and the lower surface of the base 200 is now visible. In this example embodiment of the present invention a threaded hole 300 is provided in the base 200 to allow the device to be securely coupled to a tripod or other steadying device. This threaded hole 300 fur use with a tripod is one of many possible methods of support for the system within the scope of the present invention. Other example embodiments may include clamps, legs, or other mechanical support structures to allow the system to be placed in a stable configuration. Some embodiments may use a flat base without any mechanical support structures, and simply rely of the weight of the system plus camera to maintain stability during use.

Those of skill in the art will recognize that two of these automatic tracking systems may be mechanically coupled together with an L-bracket (such that the two systems are perpendicular to each other) in order to allow both left-right and up-down tracking of the transmitter. This may be particularly useful in sports, such as baseball or golf, where one may wish to track the trajectory of the ball with a video cam while keeping the ball in focus the entire flight. In such a situation, the transmitter may be implanted in the ball to allow accurate tracking of the ball. Those of skill in the art will recognize the many uses of this technology in situations other than sports. For example, the system may be used to track the movements of animals or machinery.

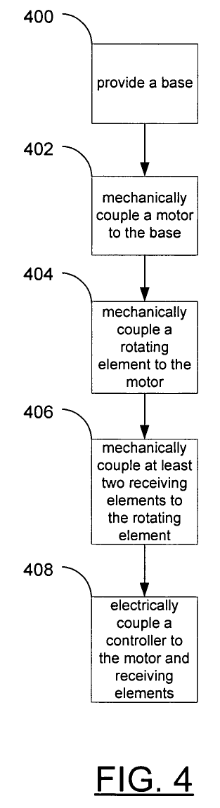

FIG. 4 is a flow chart of an example embodiment of a method of automatically tracking a transmitter according to the present invention. In a step 400, provide a base. In a step 402, mechanically couple a motor to the base. In a step 404, mechanically couple a rotating element to the motor. In a step 406, mechanically couple at least two receiving elements to the rotating element. In a step 408, electrically couple a controller to the motor and the at least two receiving elements, wherein the controller is configured to operate motor such that the at least two receiving elements always face a transmitter.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a base;
a rotating element;
a motor mechanically coupled with said base and said rotating element, configured to rotate said rotating element with respect to said base;
at least two receiving elements, mechanically coupled with said rotating element;
a controller electrically coupled to said motor and said at least two receiving elements, configured to operate said motor such that said at least two receiving elements track a transmitter.

2. A device as recited in claim 1,
wherein said transmitter operates in the 60 GHz frequency band.

3. A device as recited in claim 1,
wherein said at least two receiving elements and said controller operate as a direction finder.

4. A device as recited in claim 1,
wherein said transmitter emits a code specific to an individual controller, and
wherein said controller is configured to track only a transmitter emitting said code specific to said controller.

5. A device as recited in claim 1,
wherein said rotating element is configured to mechanically couple with a camera.

6. A device as recited in claim 5,
wherein said rotating element uses a threaded bolt to mechanically couple with a camera.

7. A device as recited in claim 1,
wherein said base is configured to mechanically couple with a tripod.

8. A device as recited in claim 7,
wherein said base includes a threaded hole configured to mechanically couple with a tripod.

9. A device as recited in claim 1,
wherein said controller is configured to calculate a distance from said receiving elements to said transmitter.

10. A device comprising:
means for detecting a direction of a transmitter;
means for rotating a rotating element with respect to a base, wherein said means for detecting a direction of a transmitter controls said means for rotating said rotating element such that said rotating element tracks said direction of said transmitter.

11. A device as recited in claim 10, further comprising:
means for mechanically coupling said base to a tripod.

12. A device as recited in claim 10, further comprising:
means for mechanically coupling said rotating element to a camera.

13. A device as recited in claim 10, further comprising:
means for calculating a distance from said rotating element to said transmitter.

14. A method comprising the steps of:
a) providing a base;
b) mechanically coupling a motor to the base;
c) mechanically coupling a rotating element to the motor;
d) mechanically coupling at least two receiving elements to the rotating element;
e) electrically coupling a controller to the motor and the at least two receiving elements, wherein said controller is configured to operate motor such that the at least two receiving elements always face a transmitter.

15. A method as recited in claim 14,
wherein the transmitter operates in the 60 GHz frequency band.

16. A method as recited in claim 14,
wherein the at least two receiving elements and the controller operate as a direction finder.

17. A method as recited in claim 14,
wherein the transmitter emits a code specific to an individual controller, and
wherein the controller is configured to track only a transmitter emitting the code specific to the controller.

18. A method as recited in claim 14,
wherein the rotating element is configured to mechanically couple with a camera.

19. A method as recited in claim 18,
wherein the rotating element uses a threaded bolt to mechanically couple with a camera.

20. A device as recited in claim 14,
wherein the base is configured to mechanically couple with a tripod.

21. A device as recited in claim 20,
wherein the base includes a threaded hole configured to mechanically couple with a tripod.

22. A device as recited in claim 14,
wherein the controller is configured to calculate a distance from the receiving elements to the transmitter.
